(19) United States
(12) Patent Application Publication
(10) Pub. No.: US 2012/0305572 A1
(43) Pub. Date: Dec. 6, 2012

(54) APPARATUS FOR PROVIDING RAPID HEATING TO LIQUID FOODSTUFFS

(76) Inventors: William D. Price, Midland, MI (US); David W. Gustafson, Midland, MI (US)

(21) Appl. No.: 13/152,399

(22) Filed: Jun. 3, 2011

(51) Int. Cl. A47J 39/00; H05B 6/64

(52) U.S. Cl. 220/592.28; 219/678

(57) ABSTRACT

A volume displacement device for heating liquid foodstuff, the volume displacement device including: (a) a body having a volume and a surface area; and (b) a boiling surface on the surface of the body.

### CROSS REFERENCE TO RELATED APPLICATIONS

Not Applicable.

### REFERENCE REGARDING FEDERALLY SPONSORED RESEARCH OR DEVELOPMENT

Not Applicable.

### SEQUENTIAL LISTING

Not Applicable.

### FIELD OF THE INVENTION

Our invention relates to a method and apparatus for improving the heating of liquid food products. In particular, our invention relates to a method and apparatus for providing the rapid heating of liquid food products, such as soups or stews, in such a way that is easy to use, non-chemical, and universally compatible.

### BACKGROUND OF THE INVENTION

Saving food for later consumption is a common practice. It is not uncommon for a user to put a liquid comestible, such as soup, into a bowl and then into the user's microwave oven to reheat. Unfortunately, due to the ‘mass’ that is formed by a bowl of liquid and due to the fact that microwave ovens tend to operate by having molecules with a strong dipole (such as water) absorb the microwave energy, there is an uneven heating profile in the radial direction of the liquid as it sits in a bowl. As a result, users typically over-heat their soup in order to provide adequate heat to all areas and, as a result, such over-heating will often cause the soup to have dehydrated or otherwise overcooked residue of soup material near the edges of the bowl and a relatively cool center of the bowl.

Thus, there is a need for an apparatus or method for improving the heating of liquid foodstuffs in a microwave oven in such a way that there is relatively even heating throughout the foodstuff.

### SUMMARY OF THE INVENTION

In a first nonlimiting embodiment, the present invention is directed to a volume displacement device for heating liquid foodstuff, the volume displacement device including: (a) a body having a volume and a surface area; and (b) a boiling surface on the surface of the body.

In a second nonlimiting embodiment, the present invention is directed to a method for heating a liquid foodstuff, the method comprising the steps of: (a) providing a vessel; (b) partially filling the vessel with liquid foodstuff; (c) placing a volume displacement device in the vessel; and (d) microwaving the filled vessel.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings in which:

FIG. 1 provides a perspective view of a nonlimiting embodiment of a volume displacement device.

FIG. 2 provides a cross sectional view of the device of FIG. 1 taken along line 2-2.

FIG. 3(a) provides a perspective view of a nonlimiting embodiment of a device.

FIG. 3(b) provides a perspective view of a nonlimiting embodiment of a device.

FIG. 3(c) provides a perspective view of a nonlimiting embodiment of a device.

FIG. 4 provides a perspective view of a nonlimiting embodiment of a device.

FIG. 5 provides a front view of a nonlimiting embodiment of a device as it may be used in a microwave oven.

### DETAILED DESCRIPTION OF THE INVENTION

One of skill in the art will appreciate that many, if not all, commercially available a microwave ovens work by passing non-ionizing microwave radiation through food or whichever material or substance is in the microwave. Water, fat, and other substances in the food absorb energy from the microwaves in a process called dielectric heating. Materials without an electric dipole will not absorb the microwave energy. Additionally, contrary to common misperception, microwave ovens do not literally heat a material from the inside out (i.e., from the center of the entire mass of food outwards) and microwave heating, like conventional heating in an oven, works by applying energy to the outer layers of the mass of food first.

### Defrosting Unit

In some embodiments the invention is a device that displaces the center volume of a liquid, gel, or fluid product in a container. Based on the physics of microwave heating as described herein, by removing a central area to receive microwave energy (i.e., providing the liquid product in a toroidal geometry rather than a semispherical, or bowl-shaped, geometry) there will be an improvement in energy distribution throughout the liquid product.

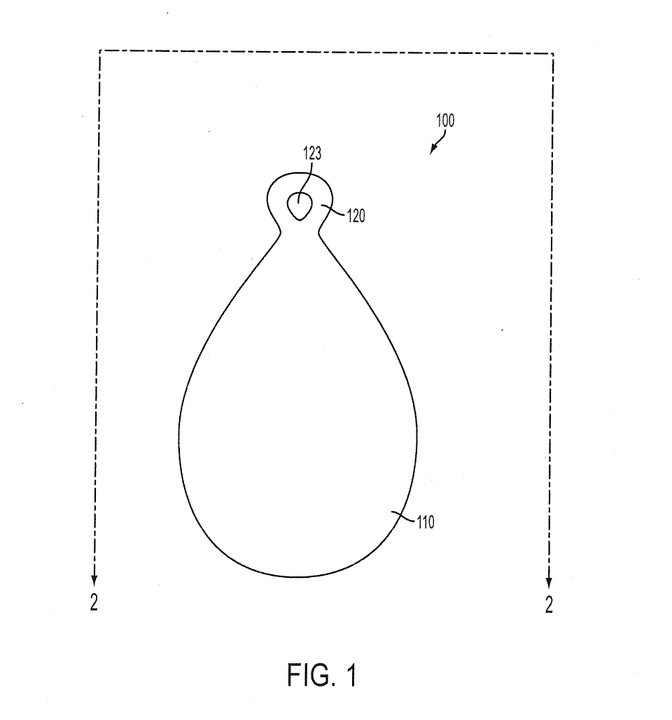

FIG. 1 provides a perspective view of a volume displacement device 100 according to a nonlimiting embodiment of the present invention. The volume displacement device 100 comprises a base 110 and an optional handle 120. In an embodiment the displacement device is made from a material selected from the group consisting of: glass, plastic, ceramic, the like and combinations thereof. One of skill in the art will appreciate that while any solid material may be used to construct such a device, it is preferred that the material be food-safe, or otherwise approved by or within component limits allowed by any regulatory body, material and that may be used with a microwave (i.e., no material such as metal which will arc in the microwave.) In a nonlimiting embodiment the volume displacement device 100 is made from a material that is a thermal insulator and/or has a relatively low coefficient of conduction and/or relatively low mass and/or relatively low density. In some embodiments the optional handle may be made of the same material that the volume displacement device is made from. The optional handle 120 may be continuous with the body 110. In other embodiments the optional handle may be a distinct part from the body 110. In particular embodiments the handle further comprises a hole 123 which may help the user pick up the device 100.

In the embodiment shown, the body of the volume displacement device 100 unit may be tear-shaped. In other embodiments, the body of the volume displacement device may have a shape selected from the group consisting of: cylindrical, spherical, egg-shaped, cubical, and the like. By providing a body 110 with a bottom portion that is substantially spherical (ex., the body 110 is tear shaped, spherical, or the like), as shown in the nonlimiting embodiment, a shape that coordinates many commonly available bowls or storage vessels. It is hypothesized that a volume displacement device having the shape of a square or rectangular cylinder may be appropriate for commonly available reusable containers, such as those available from the Ziploc® Brand Versaglass® (S.C. Johnson & Son, Inc., Racine, Wis.) wherein the container has a substantially rectangular or square shaped base.

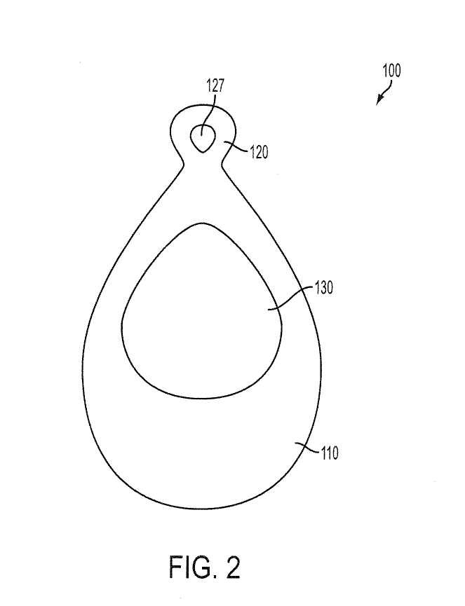

FIG. 2 is a cross-sectional view of the volume displacement device 100 of FIG. 1 taken along line 2-2. In the embodiment shown the body 110 of the volume displacement device 100 further comprises a low density volume area 130. In some embodiments the low density volume area 130 is a hollow void in the body 110. It is thought that by providing a volume 130 within the body 110 wherein the volume 130 has a relatively lower density than the body 110, the volume displacement device 100 may remain in a relatively upright position during use thus making it relatively easy for the user to remove after use as by maintaining the device 100 in an upright position due to the buoyant effect that the lower density area will have on the device 100 as a whole, there will be a “clean” area of the device 100 to hold for removal.

In particular embodiments of the present invention, the low density volume area 130 may be biased or otherwise positioned towards the relative top of the body 110 of the volume displacement device 100. In specific embodiments, the low density volume area 130 may be positioned relatively closer to a handle 120. In other embodiments, the low density volume area 130 is evenly proportioned with three dimensional shape of the volume displacement device 100.

In particular other embodiments the invention the volume of the low density volume area 130 is from about 50% to about 95% of the total volume of the device 100. In another embodiment the volume of the low density volume area 130 is from about 60% to about 80% of the total volume of the device 100. In yet another embodiment the volume of the low density volume area 130 is from about 65% to about 75% of the total volume of the device 100. The precise ratio of low density volume area 130 to body 110 is dependent on the particular materials used for the device 100. In one embodiment the volume fraction of the body PCT_{body} multiplied by the density of the material used in the body D_{body} less the volume fraction of the low density volume area PCT_{l.d.a.} multiplied by the density of the of the low density volume area D_{l.d.a} provides the relative floatability (“Float”) of the device in water.

(PCT_{body}×D_{body})−PCT_{l.d.a.}×D_{l.d.a.})=Float Eq. 1

In one embodiment the Float of a device is less than 1.0. In another embodiment, the Float of a device is from about 0.6 to 1.0. In yet another embodiment, the Float of a device is from about 0.75 to about 1.0.

In certain embodiments the low density volume area may not have any solid material therein, or may be otherwise “hollow.” However, one of skill in the art will appreciate that an enclosed space should not lead to a high pressure gradient between the “hollow” low density volume area and the atmosphere outside of the device.

In a particular embodiment the body 110 of the volume displacement device 100 may have a density that is from about 0.5 g/cm³ to about 2.6 g/cm³.

In a different embodiment the volume displacement device 100 may have a density that is from about 0.8 g/cm³ to about 0.95 g/cm³.

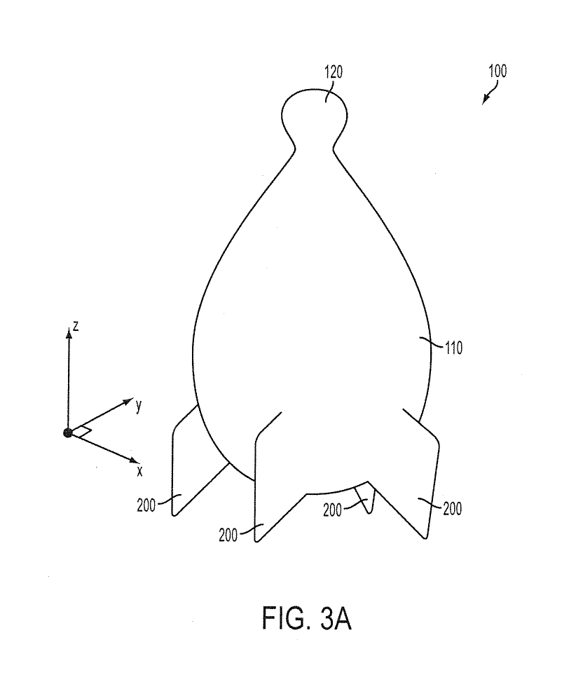

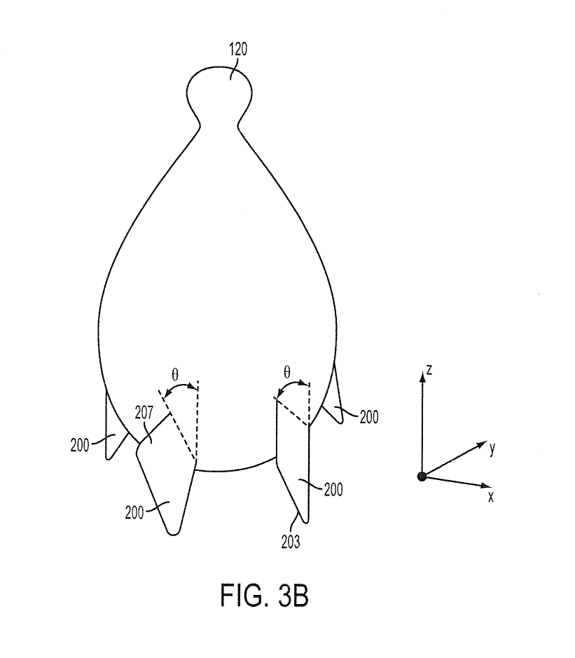

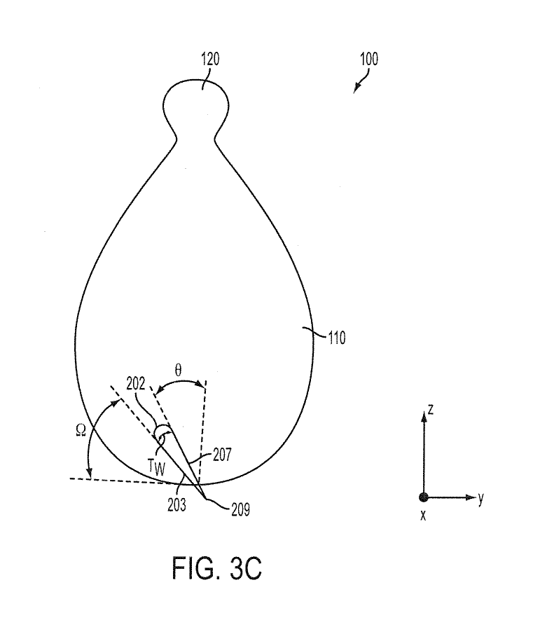

FIG. 3(a) provides a perspective view of another nonlimiting embodiment of a volume displacement device 100 wherein the device further comprises one or more wings 200 extending from the body 110. The device 100 of FIG. 3 may be understood as being relative to a Cartesian coordinate system wherein the system consists of X, Y, and Z axes wherein the X and Y axes are at a right angle forming a plane and the Z axis is perpendicular thereto. In the embodiment shown the body 110 of the device 100 may be substantially symmetrical about its Z-axis through the center of the device 100. One or more wings 200 may extend outwardly from the relative bottom portion of the body 110 of the device 100. In an embodiment the wings 200 may be spaced at regular, even intervals around the bottom part of the body 110. In another embodiment there may be any number of wings, although in particular embodiments there are from about 4 wings to about 6 wings evenly spaced about the bottom part of the body 110.

FIG. 3(b) provides a perspective view of an alternative nonlimiting embodiment of a volume displacement device 100 having one or more wings 200. Each wing 200 may have a topside 207 and an underside 203. The wings may be provided such that there is an angle θ between the topside 207 of a wing 200 relative to a wing that is parallel with the Z-axis is from about 30 degrees to about 60 degrees. In another embodiment, the angle θ is from about 30 degrees to about 50 degrees. In another embodiment still, the angle θ is from about 30 degrees to about 45 degrees.

FIG. 3(c) provides a perspective view of yet another nonlimiting embodiment of a volume displacement device 100 having one or more wings 200. In this embodiment the thickness of the wing T_{W} is variable from the topside of the wing 202 to the bottomside of the wing 209. In a particular embodiment (not shown), the face of a wing may be shaped as convex or concave to promote rotational movement of the device 100 in the liquid as bubbles form in the liquid as heating occurs. In the embodiment shown the angle θ between the topside 207 of the wing 200 relative to a wing that is parallel with the Z-axis is different from the angle Ω between the underside 203 of the wing 200 relative to a wing that is coplanar with the X-Y plane is from about 30 degrees to about 60 degrees. In another embodiment, the angle Ω is from about 40 degrees to about 60 degrees. In another embodiment still, the angle Ω is from about 45 degrees to about 60 degrees.

It is thought that providing wings 200 to the device 100 will provide rotational movement of the device 100 in the liquid as bubbles form in the liquid due to heating. Such movement may provide mixing to the liquid as heating occurs. Additionally, such movement may provide a strong visual cue to users that the device is working.

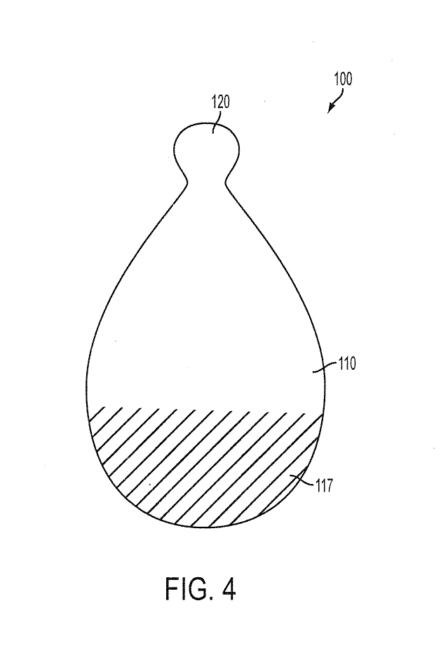

FIG. 4 shows an alternative embodiment of a volume displacement device 100 wherein the bottom portion of the body 110 of the volume displacement device 100 is relatively roughened or otherwise provided with some sort of relatively rough texture to provide a boiling area 117. The boiling area 117 is provided to expedite the boiling or rapid heating of a liquid foodstuff because the textured or roughened surface may provide nucleation sites to a liquid. In the embodiment shown the device 100 comprises a handle 120 which is optional. The roughness may be applied to anywhere from about 1% to 100% of the surface of the body 110 of the device 100. In a different embodiment the roughness may be applied to anywhere from about from about 25% to about 50% of the surface of the body 110 of the device 100. In a nonlimiting embodiment the roughness may be applied by a fine grit sand blast to the surface of the body 110 of the device 100.

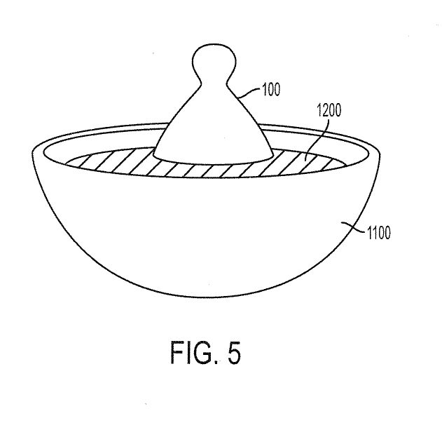

FIG. 5 shows an exemplary nonlimiting embodiment of a volume displacement device 100 as it may be used in a bowl of liquid foodstuff, such as soup. In the embodiment shown, a user may provide a bowl 1100, or other suitable holding vessel, and then provide a liquid foodstuff 1200 into the bowl 1100 or vessel such that the bowl 1100 is at least partially filled. The volume displacement device 100 may then be placed in the relative center of the bowl 1100, thus displacing the central volume of the liquid foodstuff with a material that will not absorb (or will absorb a relatively small amount of) microwave energy. The user may then heat the liquid foodstuff 1200 in a microwave (not shown) or otherwise microwave the filled vessel. After the liquid foodstuff 1200 is done in the microwave, the user may remove the device 100 and enjoy the uniformly heated liquid foodstuff 1200.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention.

We claim:

1. A volume displacement device:
a) a body having a volume and a surface area; and
b) a boiling surface on the surface of the body.

2. The volume displacement device of claim 1 wherein the body is shaped from the shapes selected from the group consisting of: cylindrical, spherical, egg-shaped, cubical, and the like.

3. The volume displacement device of claim 1 wherein the boiling surface is on the relative bottom side of the body.

4. The volume displacement device of claim 1 wherein the boiling surface is from about 1% to about 100% of the surface area of the body.

5. The volume displacement device of claim 4 wherein the boiling surface is from about 25% to about 50% of the surface area of the body.

6. The volume displacement device of claim 1 wherein the body further comprises a handle attached thereto.

7. The volume displacement device of claim 1 wherein the body further comprises a handle attached thereto.

8. The volume displacement device of claim 7 wherein the low density volume area is biased towards the relative top of the body of the volume displacement device.

9. The volume displacement device of claim 8 wherein the low density volume area is a hollow volume.

10. The volume displacement device of claim 1 wherein the volume displacement device is made of a material that does not absorb a relatively high level of microwave energy.

11. The volume displacement device of claim 1 wherein the volume displacement device is made of a material selected from the group consisting of: glass, plastic, ceramic, the like and combinations thereof.

12. A method for heating a liquid foodstuff, the method comprising the steps of:
a. providing a vessel;
b. partially filling the vessel with liquid foodstuff;
c. placing a volume displacement device in the vessel; and
d. microwaving the filled vessel.

13. The method according to claim 13 wherein:
c. the volume displacement device is placed in the relative center of the vessel.

14. The method according to claim 13 wherein:
c. the volume displacement device is placed in the relative center of the vessel, providing a relatively toroidal form to the liquid foodstuff.

15. A volume displacement device:
a) a body having a volume and a surface area;
b) a boiling surface on the surface of the body; and
c) one or more wings extending outwardly from the surface of the body.

16. The volume displacement device according to claim 15 wherein there are from about 4 to about 6 wings.

17. The volume displacement device according to claim 15 wherein the one or more wings are equally spaced about the bottom portion of the body.
